(19) United States
(12) Patent Application Publication
(10) Pub. No.: US 2023/0230738 A1
(43) Pub. Date: Jul. 20, 2023

(54) COIL COMPONENT

(71) Applicant: TDK Corporation, Tokyo (JP)

(72) Inventors: Yusuke NAGAI, Tokyo (JP); Kazuhiro EBINA, Tokyo (JP); Kunihiko KAWASAKI, Tokyo (JP); Shinichi KONDO, Tokyo (JP); Shinichi SATO, Tokyo (JP); Seiichi NAKAGAWA, Tokyo (JP); Mitsuharu KOIKE, Tokyo (JP); Takato SASAKI, Tokyo (JP); Youhei IIDA, Tokyo (JP)

(73) Assignee: TDK Corporation, Tokyo (JP)

(21) Appl. No.: 18/097,556

(22) Filed: Jan. 17, 2023

(30) Foreign Application Priority Data
Jan. 18, 2022 (JP) 2022-005515

(51) Int. Cl. H01F 5/04; H01F 5/06; H01F 27/29; H01F 27/32; H01F 1/20

(52) U.S. Cl. CPC H01F 5/04; H01F 5/06; H01F 27/292; H01F 27/323; H01F 1/20

(57) ABSTRACT

A coil component includes an element body, a coil and a first electrode part. The element body includes a main surface which is used as a mounting surface. The coil is disposed in the element body. The first electrode part is embedded in the element body and electrically connected to the coil. The first electrode part includes a first surface exposed from the main surface and a second surface opposing the first surface. An area of the first surface is larger than an area of the second surface when viewed from a direction orthogonal to the first surface.

### TECHNICAL FIELD

The present disclosure relates to coil components. This application is based upon and claims the benefit of priority from Japanese Patent Application No. 2022-005515, filed on Jan. 18, 2022, the entire contents of which are incorporated herein by reference.

### BACKGROUND

Japanese Patent Application Laid-Open No. 2009-206110 discloses a multilayer inductor including a laminate, a conductor pattern spirally formed in the laminate, and a pair of terminal electrodes formed on both end portions of a mounting surface of the laminate. The pair of terminal electrodes are joined to the wiring pattern of the mounting substrate.

### SUMMARY

The mounting strength of the multilayer inductor disclosed in Japanese Patent Application Laid-Open No. 2009-206110 is improved by increasing the joined area between the terminal electrode and the wiring pattern. However, when the size of the terminal electrode is increased, the opposing area between the terminal electrode and the conductor pattern increases, and the withstand voltage decreases.

A purpose of the present disclosure is to provide a coil component capable of suppressing a decrease in withstand voltage while securing mounting strength.

A coil component according to an aspect of the present disclosure includes an element body, a coil and a first electrode part. The element body includes a main surface which is used as a mounting surface. The coil is disposed in the element body. The first electrode part is embedded in the element body and electrically connected to the coil. The first electrode part includes a first surface exposed from the main surface and a second surface opposing the first surface. An area of the first surface is larger than an area of the second surface when viewed from a direction orthogonal to the first surface.

In the coil component according to the aspect of the present disclosure, the first surface of the first electrode part is a surface joined to another electronic device. Therefore, since the area of the first surface is larger than the area of the second surface, the mounting strength can be secured. The second surface of the first electrode part is a surface opposing the coil disposed in the element body. Therefore, since the area of the second surface is smaller than the area of the first surface, it is possible to suppress a decrease in withstand voltage between the first electrode part and the coil.

The element body may include a plurality of soft magnetic metal particles.

Two or more soft magnetic metal particles may be disposed between the coil and the first electrode part along the direction orthogonal to the first surface. In this case, the withstand voltage between the coil and the first electrode part can be improved.

A high resistance portion having an electrical resistivity higher than that of the element body may be disposed between the coil and the first electrode part. In this case, the withstand voltage between the coil and the first electrode part can be improved.

The coil component may further include a second electrode part disposed in the element body to be spaced apart from the first electrode part and electrically connected to the coil. The coil may include a plurality of coil conductors electrically connected to each other. The high resistance portion may be disposed between the first electrode part and a coil conductor among the plurality of coil conductors, the coil conductor being configured to have a potential closest to a potential of the second electrode part. In this case, the potential difference between the coil and the first electrode part is largest between the first electrode part and the coil conductor among the plurality of coil conductors, the coil conductor being configured to have the potential closest to the potential of the second electrode part. Si12nce the high resistance portion is disposed between the coil conductor and the first electrode part, the withstand voltage between the coil and the first electrode part can be reliably improved.

The coil component may further include an external electrode disposed on the element body. The element body may include a main surface on which the first electrode part is exposed and an end surface adjacent to the main surface. The external electrode may include a first electrode portion provided on the end surface and a second electrode portion connected to the first electrode portion and covering the first electrode part. In this case, the connection conductor connecting the external electrode and the coil can be led out to the end surface.

The first surface may include a region exposed on a ridge portion adjacent to the main surface of the element body. In this case, the contact area between the external electrode and the first electrode part provided on the end surface adjacent to the main surface of the element body is increased, and the electrical resistance between the external electrode and the first electrode part may be reduced.

### BRIEF DESCRIPTION OF THE DRAWINGS

FIG. 1 is a perspective view illustrating a coil component according to an embodiment.

FIG. 2 is an exploded perspective view of the coil component shown in FIG. 1.

FIG. 3 is a cross-sectional view of the coil component shown in FIG. 1.

FIG. 4 is a plan view of the first electrode part and the second electrode part.

FIG. 5 is a partially enlarged view of FIG. 3.

FIG. 6 is a cross-sectional view of a coil component according to a first modification.

FIG. 7 is an exploded perspective view of the coil component shown in FIG. 6.

FIG. 8 is a partially enlarged cross-sectional view of a coil component according to a second modification.

### DETAILED DESCRIPTION

Hereinafter, embodiments will be described in detail with reference to the accompanying drawings. In the description of the drawings, the same or corresponding elements are denoted by the same reference numerals, and redundant description is omitted.

### First Embodiment

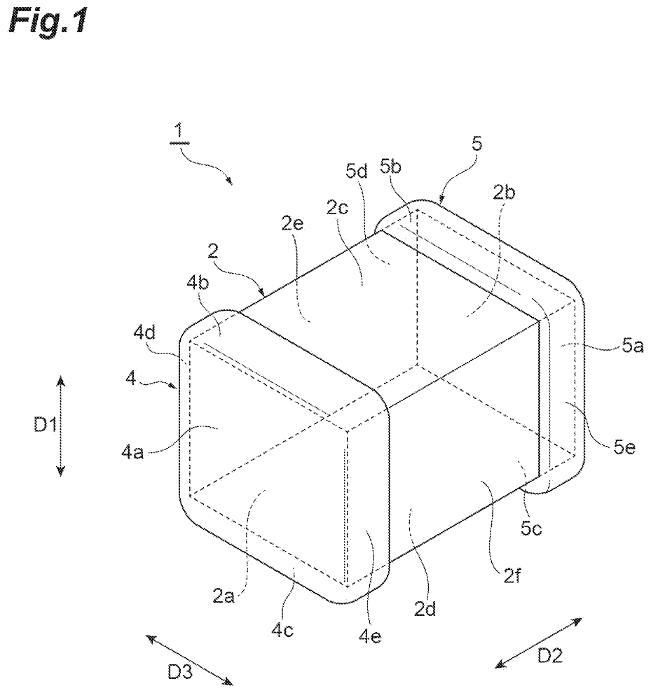

As shown in FIG. 1, a coil component 1 according to the first embodiment includes an element body 2, a first external electrode 4, and a second external electrode 5.

The element body 2 has a substantially rectangular parallelepiped shape. The rectangular parallelepiped shape includes a rectangular parallelepiped shape in which corner portions and ridge portions are chamfered and a rectangular parallelepiped shape in which corner portions and ridge portions are rounded. The element body 2 has, as its outer surface, a pair of end surfaces 2a and 2b opposing each other, a pair of main surfaces 2c and 2d opposing each other, and a pair of side surfaces 2e and 2f opposing each other. An opposing direction in which the pair of main surfaces 2c and 2d are opposed to each other is a first direction D1. An opposing direction in which the pair of end surfaces 2a and 2b are opposed to each other is a second direction D2. An opposing direction in which the pair of side surfaces 2e and 2f are opposed to each other is a third direction D3. In the present embodiment, the first direction D1 is a height direction of the element body 2. The second direction D2 is a longitudinal direction of the element body 2 and is orthogonal to the first direction D1. The third direction D3 is a width direction of the element body 2 and is orthogonal to the first direction D1 and the second direction D2.

The pair of end surfaces 2a and 2b extends in the first direction D1 so as to connect between the pair of main surfaces 2c and 2d. The pair of end surfaces 2a and 2b also extends in the third direction D3 (short side direction of the pair of main surfaces 2c and 2d). The pair of end surfaces 2a and 2b are adjacent to a main surface 2d. The pair of side surfaces 2e and 2f extends in the first direction D1 so as to connect between the pair of main surfaces 2c and 2d. The pair of side surfaces 2e and 2f also extends in the second direction D2 (long side direction of the pair of end surfaces 2a and 2b). The main surface 2d may be defined as a mounting surface that faces another electronic device (for example, a circuit board or an electronic component) when the coil component 1 is mounted on the other electronic device. The coil component 1 is connected to other electronic devices by, for example, solder.

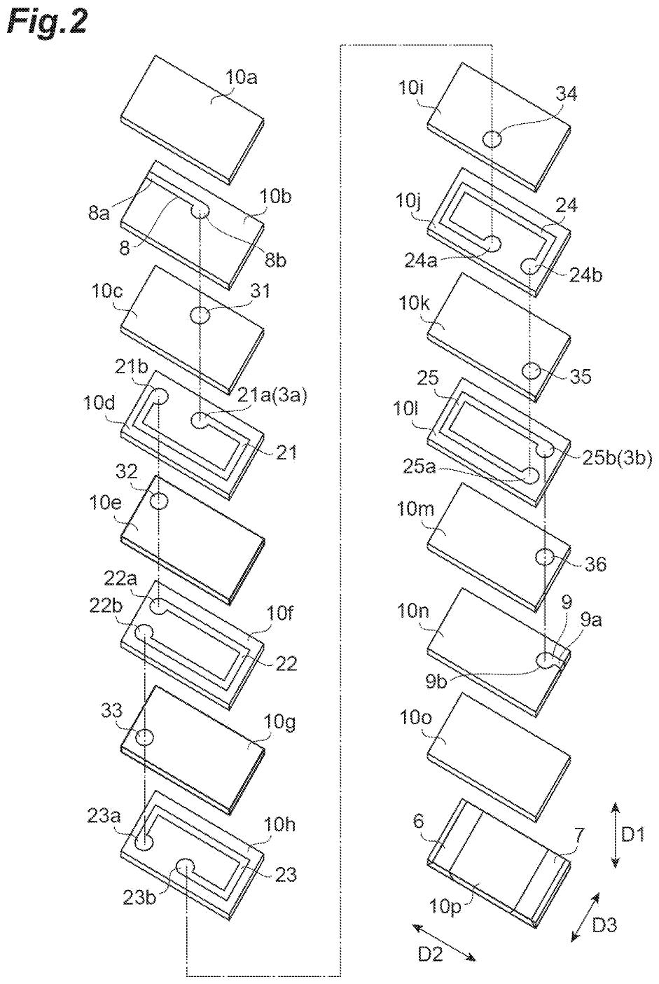

As shown in FIG. 2, the element body 2 has a plurality of element body layers 10a to 10p that are laminated in the first direction D1. The coil component 1 is a multilayer coil component. Each of the element body layers 10a to 10p is laminated in this order in the first direction D1. That is, the first direction D1 is the laminating direction. In the actual element body 2, the element body layers 10a to 10p are integrated to such an extent that the boundary between the layers cannot be visually recognized. In FIG. 2, each of the element body layer 10a to 10p is illustrated one by one, but a plurality of element body layers 10a and a plurality of element body layers 10o are laminated. The main surface 2c is constituted by the main surface of the element body layer 10a located at the laminated end. The main surface 2d is constituted by the main surface of the element body layer 10p.

The thicknesses of each element body layer 10a to 10p (lengths in the first direction D1) are, for example, 1 μm or more 200 μm or less. In FIG. 2, the thicknesses of the element body layers 10a to 10p are shown to be equal, but the element body layers 10b, 10d, 10f, 10h, 10j, 101, and 10n are thicker than the element body layers 10c 10e 10g 10i 10k 10m and 10o. The coil conductors 21 to 25, a first connection conductor 8, and a second connection conductor 9 described later are provided in the element body layers 10b, 10d, 10f, 10h, 10j, 101, and 10n. The through-hole conductors 31 to 36 described later are provided in the element body layers 10c 10e 10g 10i 10k 10m and 10o. The thicknesses of the element body layers 10b, 10d, 10f, 10h, 10j, 101, and 10n are equal to each other in the present embodiment and are, for example, 5 μm or more 200 μm or less. The thicknesses of the element body layers 10c, 10e, 10g, 10i, 10k, 10m, and 10o are equal to each other in the present embodiment and are, for example, 1 μm or more 20 μm or less.

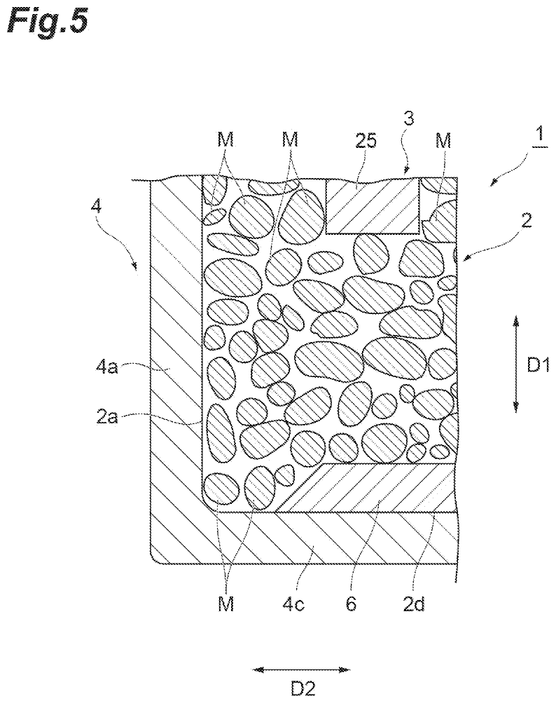

Each of the element body layers 10a to 10p includes a plurality of soft magnetic metal particles M (see FIG. 5). The soft magnetic metal particles M is made of a soft magnetic alloy (soft magnetic material). The soft magnetic alloy is, for example, an Fe—Si-based alloy.

When the soft magnetic alloy is the Fe—Si-based alloy, the soft magnetic alloy may contain P. The soft magnetic alloy may be, for example, an Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

The soft magnetic metal particles M are coupled to each other in each of the element body layers 10a to 10p. The coupling between the soft magnetic metal particles M is realized by coupling between oxide films formed on surfaces of the soft magnetic metal particles M, for example. The soft magnetic metal particles M are electrically insulated from each other by coupling of oxide films in each of the element body layers 10a to 10p. The thicknesses of the oxide films are, for example, 5 nm or more 60 nm or less. The oxide film may include one or more layers.

The element body 2 contains resins. The resins are present between the plurality of soft magnetic metal particles M. The resin is an insulating resin having electrical insulating properties. The insulating resin includes, for example, silicone resin, phenol resin, acrylic resin, or epoxy resin.

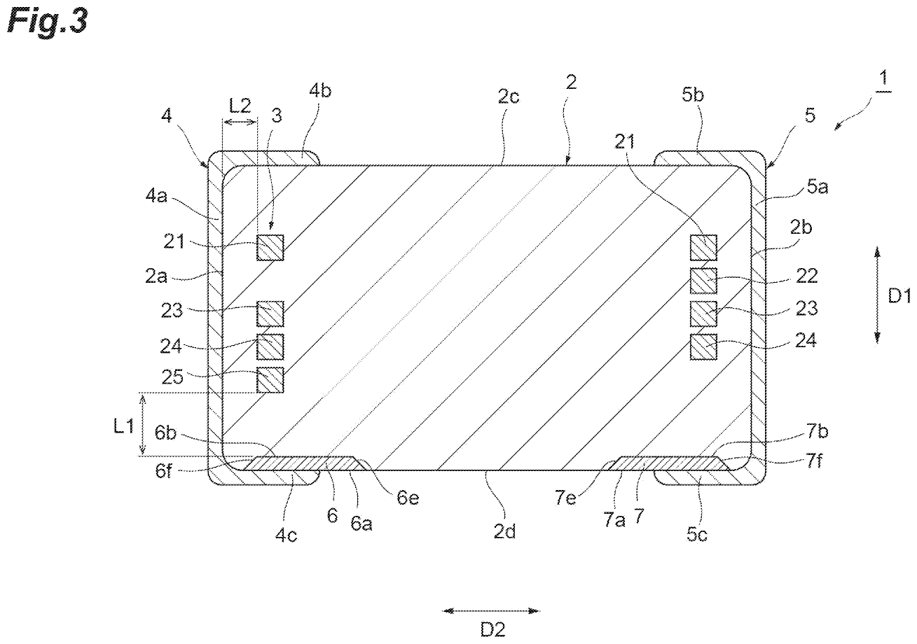

As shown in FIG. 3, in the element body 2, a part of the main surface 2d forms steps. To be specific, a portion close to each of the end surfaces 2a and the end surface 2b is recessed toward the main surface 2c from the central portion in the main surface 2d.

As shown in FIGS. 1 and 3, the first external electrode 4 and the second external electrode 5 are disposed on the element body 2. The first external electrode 4 and the second external electrode 5 are disposed on the outer surface of the element body 2. The first external electrode 4 is located at one end portion in the second direction D2 of the element body 2. The second external electrode 5 is located at the other end portion in the second direction D2 of the element body 2. The first external electrode 4 and the second external electrode 5 are spaced apart from each other in the second direction D2.

The first external electrode 4 includes a first electrode portion 4a located on the end surface 2a, a second electrode portion 4b located on the main surface 2c, a third electrode portion 4c located on the main surface 2d, a fourth electrode portion 4d located on the side surface 2e, and a fifth electrode portion 4e located on a side surface 2f. The first electrode portion 4a extends along the first direction D1 and the third direction D3 and has a rectangular shape when viewed from the second direction D2. The second electrode portion 4b extends along the second direction D2 and the third direction D3 and has a rectangular shape when viewed from the first direction D1. The third electrode portion 4c extends along the second direction D2 and the third direction D3 and has a rectangular shape when viewed from the first direction D1. The fourth electrode portion 4d extends along the first direction D1 and the second direction D2 and has a rectangular shape when viewed from the third direction D3. The fifth electrode portion 4e extends along the first direction D1 and the second direction D2 and has a rectangular shape when viewed from the third direction D3.

The first electrode portion 4a, the second electrode portion 4b, the third electrode portion 4c, the fourth electrode portion 4d, and the fifth electrode portion 4e are connected at the ridges of the element body 2, and are electrically connected to each other. The first external electrode 4 is formed on five surfaces that include the end surface 2a, the pair of main surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

The second external electrode 5 includes a first electrode portion 5a located on the end surface 2b, a second electrode portion 5b located on the main surface 2c, a third electrode portion 5c located on the main surface 2d, a fourth electrode portion 5d located on the side surface 2e, and a fifth electrode portion 5e located on the side surface 2f. The first electrode portion 5a extends along the first direction D1 and the third direction D3 and has a rectangular shape when viewed from the second direction D2. The second electrode portion 5b extends along the second direction D2 and the third direction D3 and has a rectangular shape when viewed from the first direction D1. The third electrode portion 5c extends along the second direction D2 and the third direction D3 and has a rectangular shape when viewed from the first direction D1. The fourth electrode portion 5d extends along the first direction D1 and the second direction D2 and has a rectangular shape when viewed from the third direction D3. The fifth electrode portion 5e extends along the first direction D1 and the second direction D2 and has a rectangular shape when viewed from the third direction D3.

The first electrode portion 5a, the second electrode portion 5b, the third electrode portion 5c, the fourth electrode portion 5d, and the fifth electrode portion 5e are connected at the ridges of the element body 2, and are electrically connected to each other. The second external electrode 5 are formed on five surfaces that include the end surface 2b, the pair of main surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

The first external electrode 4 and the second external electrode 5 may be conductive resin layers. As the conductive resin, a thermosetting resin mixed with a conductive material, an organic solvent and the like is used. As the conductive material, for example, a conductive filler is used. The conductive filler is a metal powder. As the metal powder, for example, Ag powder is used. As the thermosetting resin, for example, a phenol resin, an acrylic resin, a silicone resin, an epoxy resin, or a polyimide resin is used.

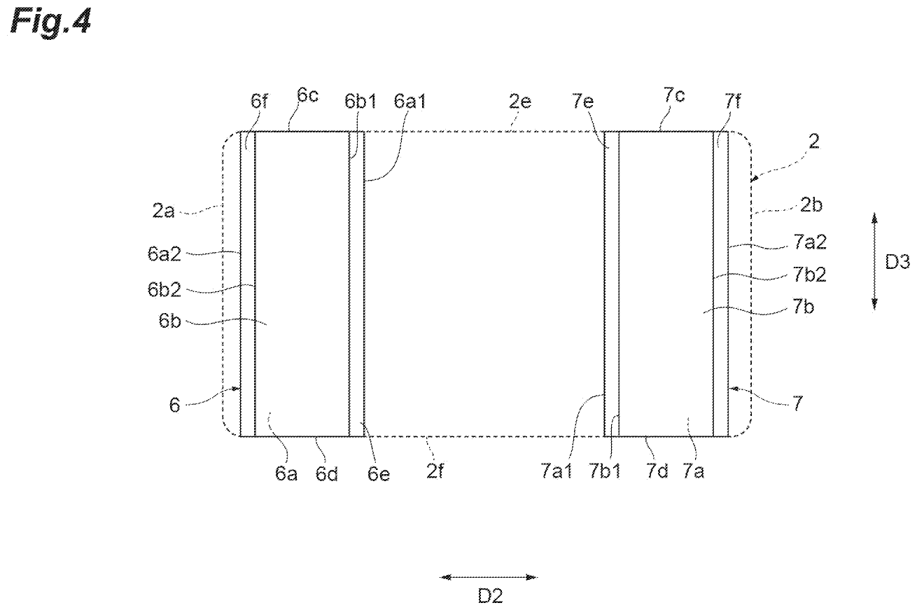

As shown in FIGS. 2 to 4, the coil component 1 further includes a first electrode part 6 and a second electrode part 7. FIG. 4 is a view seen from the main surface 2c side along the first direction D1, and the element body 2 is indicated by a broken line. The first electrode part 6 and the second electrode part 7 are provided in the element body layer 10p to be spaced apart from each other in the second direction D2. The first electrode part 6 and the second electrode part 7 are provided to penetrate the element body layer 10p in its depth direction (the first direction D1). The first electrode part 6, the second electrode part 7, and the element body layer 10p have the same thickness (the length in the first direction D1). The first electrode part 6 and the second electrode part 7 are plated conductors. The first electrode part 6 and the second electrode part 7 contain a conductive material. The conductive material is, for example, Ag, Pd, Cu, Al, or Ni.

The first electrode part 6 and the second electrode part 7 are embedded in the element body 2 so as to be spaced apart from each other in the second direction D2. The first electrode part 6 and the second electrode part 7 are electrically connected to a coil 3 described later. The first electrode part 6 is provided so as to fill a step provided on the end surface 2a side of the main surface 2d. The second electrode part 7 is provided so as to fill a step provided on the end surface 2b side of the main surface 2d. The first electrode part 6 is electrically connected to the first external electrode 4. The second electrode part 7 is electrically connected to the second external electrode 5.

The first electrode part 6 includes a first surface 6a, a second surface 6b, a third surface 6c, a fourth surface 6d, a fifth surface 6e, and a sixth surface 6f. The first surface 6a and the second surface 6b face each other in the first direction D1 and are parallel to each other. The third surface 6c, the fourth surface 6d, the fifth surface 6e, and the sixth surface 6f connect the first surface 6a and the second surface 6b.

The first surface 6a is exposed from the main surface 2d. The first surface 6a constitutes the same plane as the main surface 2d. The first surface 6a is covered with the third electrode portion 4c and is in contact with the third electrode portion 4c. The first surface 6a includes a first end 6a1 close to the end surface 2b and a second end 6a2 close to the end surface 2a. The part including the second end 6a2 in the first surface 6a is covered by the third electrode portion 4c. The part including the first end 6a1 in the first surface 6a is exposed from the third electrode portion 4c.

The second surface 6b is located inside the element body 2 with respect to the main surface 2d. In the first direction D1, the separation distance between the second surface 6b and main surface 2c is shorter than the separation distance between the main surface 2d and main surface 2c. In the present specification, the separation distance means the shortest separation distance. The entire surface of the second surface 6b is in contact with the element body 2. The second surface 6b includes a first end 6b1 close to the end surface 2b and a second end 6b2 close to the end surface 2a.

The first surface 6a and the second surface 6b have a rectangular shape when viewed from the first direction D1. When viewed from the first direction D1, the area of the first surface 6a is larger than the area of the second surface 6b. The lengths of the first surface 6a and the second surface 6b in the third direction D3 are equal to those of the main surface 2d in the third direction D3. The length of the first surface 6a in the second direction D2 is longer than the length of the second surface 6b in the second direction D2. When viewed from the first direction D1, the first end 6a1 is located closer to the end surface 2a than the first end 6b1. When viewed from the first direction D1, the second end 6a2 is located closer to the end surface 2b than the second end 6b2.

The third surface 6c is exposed from the side surface 2e. The third surface 6c constitutes the same plane as the side surface 2e. The fourth surface 6d is exposed from the side surface 2f. The fourth surface 6d constitutes the same plane as the side surface 2e. The third surface 6c and the fourth surface 6d are opposing each other in the third direction D3. The third surface 6c and the fourth surface 6d have the same shape. The third surface 6c and the fourth surface 6d have a trapezoidal shape. The third surface 6c and the fourth surface 6d are arranged parallel to each other.

The fifth surface 6e is opposed to the second electrode part 7 in the second direction D2. The fifth surface 6e connects the first end 6a1 and the first end 6b1. The fifth surface 6e is inclined with respect to the first direction D1. The fifth surface 6e is disposed inside the element body 2. The entire surface of the fifth surface 6e is in contact with the element body 2. The fifth surface 6e has a rectangular shape. As seen from the first direction D1, the entire the fifth surface 6e overlaps the first surface 6a.

The sixth surface 6f is opposed to the fifth surface 6e in the second direction D2. The sixth surface 6f connects the second end 6a2 and the second end 6b2. The sixth surface 6f is inclined with respect to the first direction D1. The sixth surface 6f is disposed inside the element body 2. The entire surface of the sixth surface 6f is in contact with the element body 2. The sixth surface 6f has a rectangular shape. As seen from the first direction D1, the entire the sixth surface 6f overlaps the first surface 6a.

The second electrode part 7 has a first surface 7a, a second surface 7b, a third surface 7c, a fourth surface 7d, a fifth surface 7e, and a sixth surface 7f. The first surface 7a and the second surface 7b face each other in the first direction D1 and are parallel to each other. The third surface 7c, the fourth surface 7d, the fifth surface 7e, and the sixth surface 7f connect the first surface 7a and the second surface 7b.

The first surface 7a is exposed from the main surface 2d. The first surface 7a constitutes the same plane as the main surface 2d. The first surface 7a is covered with the third electrode portion 5c and is in contact with the third electrode portion 5c. The first surface 7a includes a first end 7a1 close to the end surface 2a and a second end 7a2 close to the end surface 2b. The part including the second end 7a2 in the first surface 7a is covered by the third electrode portion 5c. The part including the first end 7a1 in the first surface 7a is exposed from the third electrode portion 5c.

The second surface 7b is located inside the element body 2 with respect to the main surface 2d. In the first direction D1, the separation distance between the second surface 7b and main surface 2c is shorter than the separation distance between the main surface 2d and main surface 2c. The entire surface of the second surface 7b is in contact with the element body 2. The second surface 7b includes a first end 7b1 close to the end surface 2a and a second end 7b2 close to the end surface 2b.

The first surface 7a and the second surface 7b have a rectangular shape when viewed from the first direction D1. When viewed from the first direction D1, the area of the first surface 7a is larger than the area of the second surface 7b. The lengths of the first surface 7a and the second surface 7b in the third direction D3 are equal to the length of the main surface 2d in the third direction D3. The length of the first surface 7a in the second direction D2 is longer than the length of the second surface 7b in the second direction D2. As seen from the first direction D1, the first end 7a1 is located closer to the end surface 2a than the first end 7b1. As seen from the first direction D1, the second end 7a2 is located closer to the end surface 2b than the second end 7b2.

The third surface 7c is exposed from the side surface 2e. The third surface 7c constitutes the same plane as the side surface 2e. The fourth surface 7d is exposed from the side surface 2f. The fourth surface 7d constitutes the same plane as the side surface 2e. The third surface 7c and the fourth surface 7d are opposing each other in the third direction D3. The third surface 7c and the fourth surface 7d have the same shape. The third surface 7c and the fourth surface 7d have a trapezoidal shape. The third surface 7c and the fourth surface 7d are arranged parallel to each other.

The fifth surface 7e is opposed to the fifth surface 6e of the first electrode part 6 in the second direction D2. The fifth surface 7e connects the first end 7a1 and the first end 7b1. The fifth surface 7e is inclined with respect to the first direction D1. The fifth surface 7e is disposed inside the element body 2. The entire surface of the fifth surface 7e is in contact with the element body 2. The fifth surface 7e has a rectangular shape. As seen from the first direction D1, the entire the fifth surface 7e overlaps the first surface 7a.

The sixth surface 7f is opposed to the fifth surface 7e in the second direction D2. The sixth surface 7f connects the second end 7a2 and the second end 7b2. The sixth surface 7f is inclined with respect to the first direction D1. The sixth surface 7f is disposed inside the element body 2. The entire surface of the sixth surface 7f is in contact with the element body 2. The sixth surface 7f has a rectangular shape. As seen from the first direction D1, the entire the sixth surface 7f overlaps the first surface 7a.

As seen from the third direction D3, the first electrode part 6 has a tapered shape in which the length in the second direction D2 gradually decreases from the first surface 6a toward the second surface 6b. As seen from the third direction D3, the second electrode part 7 has a tapered shape in which the length in the second direction D2 gradually decrease from the first surface 7a toward the second surface 7b.

As shown in FIGS. 2 and 3, the coil component 1 further includes the coil 3, the first connection conductor 8, and the second connection conductor 9.

The coil 3 is disposed in the element body 2. The coil 3 is spaced apart from the outer surface of the element body 2. In the present embodiment, the coil 3 is located at the center of element body 2 in each of the second direction D2 and the third direction D3. That is, the separation distance between the coil 3 and the end surface 2a and the separation distance between the coil 3 and the end surface 2b are equal to each other. The separation distance between the coil 3 and the side surface 2e and the separation distance between the coil 3 and the side surface 2f are equal to each other.

A separation distance L1 between the coil 3 and the first electrode part 6 is longer than a separation distance L2 between the coil 3 and the first electrode portion 4a, that is, the separation distance between the coil 3 and the end surface 2a. The separation distance between the coil 3 and the second electrode part 7 is equivalent to the separation distance L1. The separation distance between the coil 3 and the first electrode portion 5a, that is, the separation distance between the coil 3 and the end surface 2b is equivalent to the separation distance L2.

The coil 3 includes coil conductors 21 to 25 and through-hole conductors 31 to 36 which are electrically connected to each other. The coil conductors 21 to 25 and the through-hole conductors 31 to 36 are inner conductors disposed inside the coil 3 together with the first connection conductor 8 and the second connection conductor 9. The inner conductor is, for example, a conductor formed by screen printing or plating. The inner conductor includes an electrically conductive material. The conductive material is, for example, Ag, Pd, Cu, Al, or Ni. The inner conductors are made of the same material, for example. The inner conductor is made of, for example, the same material as the first electrode part 6 and the second electrode part 7.

The coil axes of the coils 3 are provided along the first direction D1. The coil conductors 21 to 25 are arranged so as to at least partially overlap each other when viewed from the first direction D1. One end portion 21a of a coil conductor 21 constitutes one end portion 3a of the coil 3. The other end portion 21b of the coil conductor 21 is connected by a through-hole conductor 32 to one end portion 22a of a coil conductor 22. The other end portion 22b of the coil conductor 22 is connected by a through-hole conductor 33 to one end portion 23a of a coil conductor 23. The other end portion 23b of the coil conductor 23 is connected by a through-hole conductor 34 to one end portion 24a of a coil conductor 24. The other end portion 24b of the coil conductor 24 is connected by a through-hole conductor 35 to one end portion 25a of a coil conductor 25. The other end portion 25b of the coil conductor 25 constitutes the other end portion 3b of the coil 3.

Each of the end portions 21a to 25a and 21b to 25b of the coil conductors 21 to 25 is formed in a circular shape when viewed from the first direction D1. When viewed from the first direction D1, the diameter of each end portion 21a to 25a and 21b to 25b is greater than a line width of each coil conductor 21 to 25. The line width is line widths of the portions other than the end portions 21a to 25a and 21b to 25b of the coil conductors 21 to 25. Since each end portion 21a to 25a and 21b to 25b is enlarged, the end portions 21a to 25a and 21b to 25b can be easily connected to the through-hole conductors 31 to 36. The diameter of each end portion 21a to 25a and 21b to 25b is equivalent to the diameters of each through-hole conductor 31 to 36.

The coil conductor 21 is provided on the element body layer 10d. The coil conductor 22 is provided on the element body layer 10f. The coil conductor 23 is provided on the element body layer 10h. The coil conductor 24 is provided on the element body layer 10j. The coil conductor 25 is provided on the element body layer 10l. The coil conductors 21 to 25 are provided so as to pass through the corresponding element body layers 10d, 10f, 10h, 10j, and 101 in the thickness direction (that is, the first direction D1) thereof. The coil conductor 21 is arranged closest to the main surface 2c among the coil conductors 21 to 25. The coil conductor 25 is arranged closest to the main surface 2d among the coil conductors 21 to 25.

The lengths of the coil conductors 21 to 25 in the first direction D1 are equal to each other in present embodiment. The lengths of the coil conductors 21 to 25 in the first direction D1 are equivalent to the thicknesses of the corresponding element body layers 10d, 10f, 10h, 10j and 10l.

The through-hole conductor 31 is provided on the element body layer 10c. The through-hole conductor 32 is provided on the element body layer 10e. The through-hole conductor 33 is provided on the element body layer 10g. The through-hole conductor 34 is provided on the element body layer 10i. The through-hole conductor 35 is provided on the element body layer 10k. The through-hole conductor 36 is provided on the element body layer 10m. Each of the through-hole conductors 31 to 36 is provided so as to pass through the corresponding element body layers 10c, 10e, 10g, 10i, 10k, and 10m in the thickness direction (that is, the first direction D1) thereof.

The lengths of the through-hole conductors 31 to 36 in the first direction D1 are equal to each other in present embodiment. The lengths of the through-hole conductors 31 to 36 in the first direction D1 are equal to the thicknesses of the corresponding element body layers 10c, 10e, 10g, 10i, 10k, and 10m.

The first connection conductor 8 connects one end portion 3a of the coil 3 to the first electrode portion 4a of the first external electrode 4. The coil conductor 21 including the end portion 3a is configured to have the same potential as the first external electrode 4. The first connection conductor 8 extends in the second direction D2. The first connection conductor 8 has a first end portion 8a and a second end portion 8b. The first end portion 8a is exposed from the end surface 2a and connected to the first electrode portion 4a.

The second end portion 8b is connected to one end portion 3a of the coil 3 by the through-hole conductor 31. The second end portion 8b is formed in a circular shape when viewed from the first direction D1. As viewed from the first direction D1, the diameter of the second end portion 8b is greater than the line widths of portions other than both end portions 8a and 8b of the first connection conductor 8. Since the second end portion 8b is enlarged in this manner, the second end portion 8b and the through-hole conductor 31 are easily connected.

The second connection conductor 9 connects the other end portion 3b of the coil 3 and the first electrode portion 5a of the second external electrode 5. The coil conductor 25 including the end portion 3b is configured to have the same potential as the second external electrode 5. The potential of the coil conductor 25 is closest to that of the second electrode part 7 among the plurality of coil conductors 21 to 25. The second connection conductor 9 extends in the second direction D2. The second connection conductor 9 extends in the second direction D2. The second connection conductor 9 has a first end portion 9a and a second end portion 9b.

The second end portion 9b is connected to the other end portion 3b of the coil 3 by the through-hole conductor 36. The second end portion 9b is formed in a circular shape when viewed from the first direction D1. As viewed from the first direction D1, the diameter of the second end portion 9b is greater than the line widths of portions other than both end portions 9a and 9b of the second connection conductor 9. Since the second end portion 9b is enlarged in this manner, the second end portion 9b and the through-hole conductor 36 are easily connected.

As shown in FIG. 5, two or more soft magnetic metal particles M are disposed between the coil conductor 25 (the coil 3) and the first electrode part 6 along the first direction D1. The potential difference between the coil 3 and the first electrode part 6 is greatest between the coil conductor 25 and the first electrode part 6. The average particle diameter of the soft magnetic metal particles M is, for example, 0.5 μm or more and 50 μm or less. In FIG. 5, hatching of resins present between the soft magnetic metal particles M is omitted. Although not shown, two or more soft magnetic metal particles M are also disposed between the coil 3 and the second electrode part 7 along the direction (the first direction D1) orthogonal to the first surface 7a.

The average particle diameter is obtained, for example, as follows. A cross-sectional photograph of the coil component 1 is obtained. The cross-sectional photograph is obtained, for example, by photographing a cross-section obtained by cutting the coil component 1 in a plane parallel to the pair of side surfaces 2e and 2f and spaced apart from the pair of side surfaces 2e and 2f by predetermined distances. In this case, the plane may be located equidistant from the pair of side surfaces 2e and 2f. The obtained cross-sectional photograph is subjected to image processing by software. The boundary of the soft magnetic metal particles M is determined by image processing, and the area of the soft magnetic metal particle M is obtained. From the obtained area of the soft magnetic metal particle M, a particle diameter converted into a circle equivalent diameter is obtained. Here, the particle diameters of 100 or more soft magnetic metal particles M are calculated, and the particle diameter distribution of the soft magnetic metal particles M is obtained. A particle diameter (d50) at an integrated value of 50% in the obtained particle diameter distribution is defined as an “average particle diameter”. The shapes of the soft magnetic metal particles M particles are not particularly limited.

Next, a method of manufacturing the coil component 1 will be described.

The soft magnetic metal particles M, insulating resins, solvents and the like are mixed to prepare slurry. The prepared slurry is provided on a base material (for example, a polyethylene terephthalate film) by, for example, a screen printing method or a doctor-blade method to form a plurality of green sheets serving as the plurality of element body layers 10a on the base material. Similarly, a plurality of green sheets serving as the plurality of element body layers 10o is formed on the base material.

A conductor pattern to be the first connection conductor 8 is formed on a base material by screen printing or plating. Subsequently, the slurry is applied onto the base material by, for example, the screen printing so as to fill the periphery of the conductor pattern. Thus, a plurality of green sheets serving as the plurality of element body layers 10b is formed on the base material. A plurality of green sheets which becomes the plurality of element body layers 10c to 10n and 10p is also formed so as to fill the periphery after forming the corresponding conductor pattern on a base material.

Next, green sheets to be element body layers 10a to 10p are transferred and laminated together with the conductor pattern in this order. The green sheets are pressed from the laminating direction to form a laminate. Subsequently, the laminate of the green sheets is fired to form a laminate substrate. Subsequently, the laminate substrate is cut into chips of a predetermined size by a cutting machine including a rotary blade to form individualized laminates. Next, the corner portions and ridge portions of the laminate are chamfered by barrel polishing.

Subsequently, the laminate is immersed in a resin solution to impregnate the laminate with the resin. Thus, the element body 2 is formed. Next, resin electrode layers serving as the first external electrode 4 and the second external electrode 5 are formed on both end portions of the element body 2 by, for example, a dipping method. As described above, the coil component 1 is formed.

As described above, in the coil component 1, the first surface 6a of the first electrode part 6 is a surface joined to another electronic device by solder, for example. Therefore, since the area of the first surface 6a is larger than the area of the second surface 6b, the joined area between the first surface 6a and the other electronic device increases, and the mounting strength can be secured. The second surface 6b of the first electrode part 6 is the surface opposing the coil 3 that is disposed in the element body 2. Therefore, since the area of the second surface 6b is smaller than the area of the first surface 6a, the opposing area between the second surface 6b and the coil 3 can be reduced. Therefore, it is possible to suppress a decrease in withstand voltage between the first electrode part 6 and the coil 3. Since the opposing area between the second surface 6b and the coil 3 is reduced, the stray capacitance between the first electrode part 6 and the coil 3 can be suppressed. The separation distance L1 is longer than the separation distance L2. Therefore, the withstand voltage between the first electrode part 6 and the coil 3 can be further suppressed, and the stray capacitance between the first electrode part 6 and the coil 3 can be further suppressed.

The element body 2 includes the plurality of soft magnetic metal particles M.

Between the coil 3 and the first electrode part 6, two or more soft magnetic metal particles M are disposed along the direction (the first direction D1) orthogonal to the first surface 6a. Therefore, the withstand voltage between the coil 3 and the first electrode part 6 can be improved.

The first external electrode 4 includes the first electrode portion 4a disposed on the end surface 2a and the third electrode portion 4c connected to the first electrode portion 4a and covering the first electrode part 6. Therefore, the first connection conductor 8 connecting the first external electrode 4 and the coil 3 can be led out to the end surface 2a. The second external electrode 5 includes the first electrode portion 5a disposed on the end surface 2b and the third electrode portion 5c connected to the first electrode portion 5a and covering the second electrode part 7. Therefore, the second connection conductor 9 connecting the second external electrode 5 and the coil 3 can be led out to the end surface 2b.

### Second Embodiment

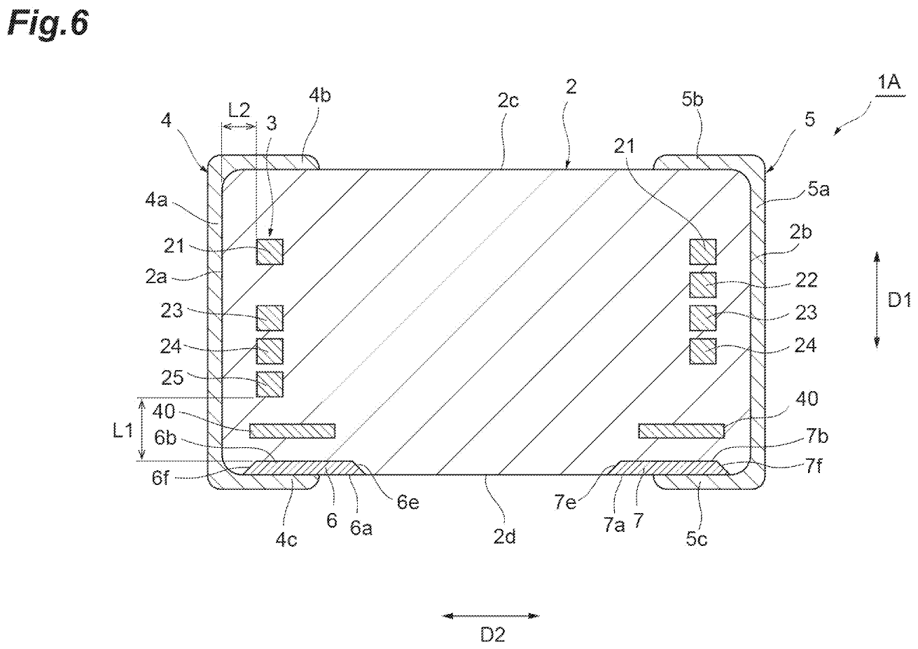

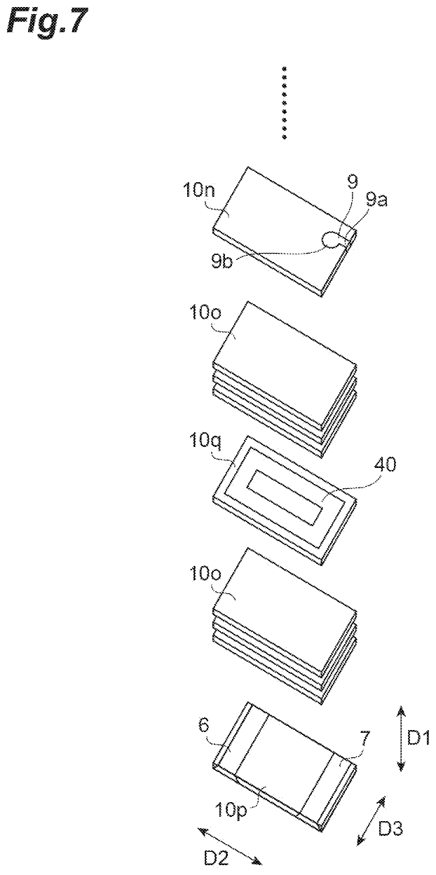

As shown in FIGS. 6 and 7, a coil component 1A according to the second embodiment mainly differs from the coil component 1 in that it further includes a high resistance portion 40 provided in the element body 2. In FIG. 7, the element body layers 10a to 10m are not shown. The high resistance portion 40 is located between the coil 3 and each of the first electrode part 6 and the second electrode part 7. The electrical resistivity of the high resistance portion 40 is higher than the electrical resistivity of the element body 2.

The coil component 1A is formed by laminating the plurality of element body layers 10a to 10p and the element body layer 10q on which the high resistance portion 40 is disposed. Like the element body layers 10a to 10p, the element body layer 10q includes the plurality of soft magnetic metal particles M (see FIG. 5). The element body layer 10q is placed between the element body layer 10n on which the second connection conductor 9 is disposed and the element body layer 10p on which the first electrode part 6 and the second electrode part 7 are disposed. The element body layer 10q is disposed, for example, between the element body layer 10o and the element body layer 10o.

The high resistance portion 40 is provided so as to pass through the element body layer 10q in its thickness direction (the first direction D1). The thickness of the high resistance portion 40 and the thickness (length in the first direction D1) of the element body layer 10q are equal to each other. The high resistance portion 40 has an electrical resistivity that is higher than the electrical resistivity of the element body 2. The high resistance portion 40 is formed, for example, of ZrO₂.

As described above, the coil conductor 25 is configured to have the potential closest to the potential of the second electrode part 7 among the plurality of coil conductors 21 to 25. Thus, the potential difference between the coil 3 and the first electrode part 6 is the largest between the first electrode part 6 and the coil conductor 25 among the plurality of coil conductors 21 to 25. The high resistance portion 40 is disposed between the coil conductor 25 and the first electrode part 6. In the present embodiment, the high resistance portion 40 is arranged so as to overlap the entire coil 3 as viewed from the first direction D1. The high resistance portion 40 has, for example, a rectangular frame shape. As viewed from the first direction D1, the line width of the high resistance portion 40 are equal to or greater than the line widths of the coil conductors 21 to 25. As described above, the line widths of the coil conductors 21 to 25 are line widths of portions other than the end portions 21a to 25a and 21b to 25b of the coil conductors 21 to 25 when viewed from the first direction D1. The high resistance portion 40 is not limited to a frame shape and may be a rectangular shape or the like. When the high resistance portion 40 has the rectangular shape, the outer edge of the high resistance portion 40 covers the outer edges of the coil conductors 21 to 25 when viewed from the first direction D1.

In order to form the high resistance portion 40 by ZrO₂, a green sheet to be the element body layer 10q is formed, and a through-portion is formed by laser processing at a position where the high resistance portion 40 (void) is to be formed in the green sheet. Subsequently, the through-portion is filled with a paste containing ZrO₂. Next, green sheets to be the plurality of element body layers 10a to 10p are transferred and laminated together with the conductor patterns in this order. The laminated green sheets are pressed from the laminating direction to form a laminate of green sheets. The high resistance portion 40 is formed in the element body layer 10q by firing the laminate of the green sheets.

In the coil component 1A, since the high resistance portion 40 is disposed between the coil 3 and the first electrode part 6, the withstand voltage between the coil 3 and the first electrode part 6 can be improved. The potential difference between the coil 3 and the first electrode part 6 is greatest between the coil conductor 25 and the first electrode part 6. Since the high resistance portion 40 is disposed between the coil conductor 25 and the first electrode part 6, the withstand voltage between the coil 3 and the first electrode part 6 can be surely improved. In a case where the high resistance portion 40 is disposed only between the coil conductor 25 and the first electrode part 6, the thickness (length in the first direction D1) of a portion where the high resistance portion 40 is present are likely to be different from the thickness (length in the first direction D1) of a portion where the high resistance portion 40 is absent when the green sheet to be the element body layer 10q is formed. As a result, the coil component 1A may be distorted. In the present embodiment, since the high resistance portion 40 is also disposed between the coil conductor 25 and the second electrode part 7, it is possible to manufacture the coil component 1A in a balanced manner while suppressing distortion.

In the coil component 1A, the embodiment in which the high resistance portion 40 is formed by ZrO₂ has been described as an example. However, for example, the high resistance portion 40 may be a void. When the high resistance portion 40 is a void, a green sheet to be the element body layer 10q is formed, and a through-portion is formed by laser processing at a position where the high resistance portion 40 (void) is formed in the green sheet. Subsequently, the through-portion is filled with a resin which disappears when the laminate of the green sheets is fired. By firing the laminate of the green sheets, the resin disappears and voids are formed. Even in this case, the withstand voltage between the coil 3 and the first electrode part 6 can be improved.

### Third Embodiment

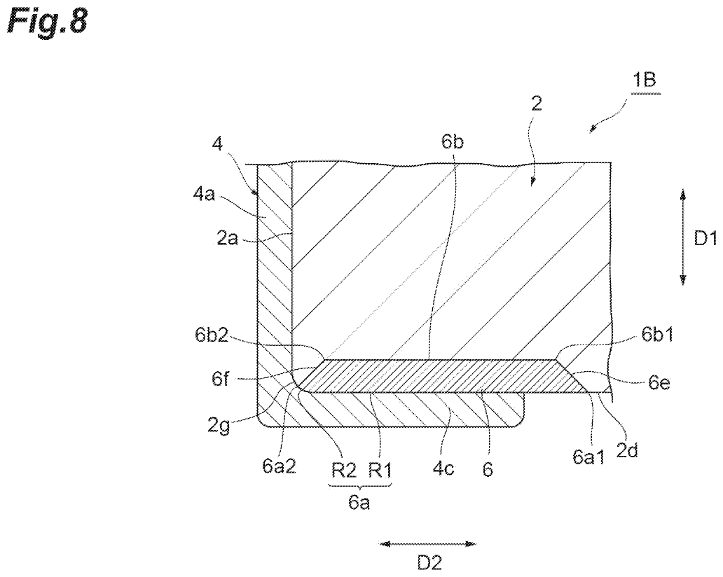

As shown in FIG. 8, a coil component 1B according to the third embodiment mainly differs from the coil component 1 in that the first surface 6a includes a second region R2 exposed on the ridge portion 2g between the main surface 2d and the end surface 2a in the element body 2 in addition to the first region R1 exposed on the main surface 2d. The ridge portion 2g is adjacent to each of the main surface 2d and the end surface 2a. The second surface 6b is opposed to at least the first region R1 of the first surface 6a in the first direction D1. The second region R2 has a curved shape. In the coil component 1B, since the area of the first surface 6a is larger than the area of the second surface 6b when viewed from the first direction D1, the same effect as that of the coil component 1 is exhibited. Since the first surface 6a includes the second region R2 exposed on the ridge portion 2g, the contact area between the first external electrode 4 and the first electrode part 6 is increased and the electrical resistance between the first external electrode 4 and the first electrode part 6 can be reduced.

In the coil component 1B, when viewed from the first direction D1, the second end 6a2 is located closer to the end surface 2a than the second end 6b2, but when viewed from the first direction D1, the second end 6a2 and the second end 6b2 may match each other. In this case, the first electrode part 6 may not include the sixth surface 6f.

In the coil component 1B, the embodiment in which the first surface 6a of the first electrode part 6 is exposed on the ridge portion 2g has been described as an example. However, for example, the first surface 7a of the second electrode part 7 may be exposed on the ridge portion between the main surface 2d and the end surface 2b of the element body 2. In this case, the contact area between the second external electrode 5 and the second electrode part 7 increases and the electrical resistance between the second external electrode 5 and the second electrode part 7 can be reduced.

Although the embodiments of the present invention have been described above, the present invention is not necessarily limited to the above-described embodiments, and various modifications can be made without departing from the scope of the present invention.

The element body 2 does not necessarily include the soft magnetic metal particles, and may be made of ferrite (for example, Ni—Cu—Zn ferrite, Ni—Cu—Zn—Mg ferrite, or Cu—Zn ferrite), a dielectric material, or the like. The coil conductors 21 to 25, the through-hole conductors 31 to 36, the first connection conductor 8, the second connection conductor 9, the first electrode part 6, and the second electrode part 7 may be sintered metal conductors.

The second end portion 8b of the first connection conductor 8, the second end portion 9b of the second connection conductor 9, and the end portions 21a to 25a and 21b to 25b of the coil conductors 21 to 25 are enlarged when viewed from the first direction D1, but may not be enlarged.

The first connection conductor 8 and the coil conductor 21 are disposed on the element body layers different from each other, but may be disposed on the same element body layer. In this case, the first connection conductor 8 and the coil conductor 21 are directly connected so as to be continuous within the same element body layer without the through-hole conductor 31. The second connection conductor 9 and the coil conductor 25 are disposed on the element body layers different from each other, but may be disposed on the same element body layer. In this case, the second connection conductor 9 and the coil conductor 25 are directly connected so as to be continuous within the same element body layer without the through-hole conductor 36.

The first external electrode 4 may not include the second electrode portion 4b. The second external electrode 5 may not include the second electrode portion 5b.

While the first connection conductor 8 is exposed on the end surface 2a and the second connection conductor 9 is exposed on the end surface 2b, the first connection conductor 8 and the second connection conductor 9 may be exposed on the main surface 2d.

1. A coil component comprising:
an element body including a main surface which is used as a mounting surface;
a coil disposed in the element body; and
a first electrode part embedded in the element body and electrically connected to the coil,
wherein the first electrode part includes a first surface exposed from the main surface and a second surface opposing the first surface, and
an area of the first surface is larger than an area of the second surface when viewed from a direction orthogonal to the first surface.

2. The coil component according to claim 1, wherein the element body includes a plurality of soft magnetic metal particles.

3. The coil component according to claim 2, wherein two or more soft magnetic metal particles are disposed between the coil and the first electrode part along the direction orthogonal to the first surface.

4. The coil component according to claim 1, wherein a high resistance portion having an electrical resistivity higher than that of the element body is disposed between the coil and the first electrode part.

5. The coil component according to claim 4, further comprising a second electrode part disposed in the element body to be spaced apart from the first electrode part and electrically connected to the coil,
wherein the coil includes a plurality of coil conductors electrically connected to each other, and
the high resistance portion is disposed between the first electrode part and a coil conductor among the plurality of coil conductors, the coil conductor being configured to have a potential closest to a potential of the second electrode part.

6. The coil component according to claim 1, further comprising, an external electrode disposed on the element body,
wherein the element body includes a main surface on which the first electrode part is exposed and an end surface adjacent to the main surface, and
the external electrode includes a first electrode portion provided on the end surface and a second electrode portion connected to the first electrode portion and covering the first electrode part.

7. The coil component according to claim 1, wherein the first surface includes a region exposed on a ridge portion adjacent to the main surface of the element body.

8. The coil component according to claim 2, wherein the element body includes a resin that is present between the plurality of soft magnetic metal particles.

9. The coil component according to claim 8, wherein the resin has an electrical insulating property.

10. The coil component according to claim 4, wherein the high resistance portion is formed of ZrO₂.

11. The coil component according to claim 4, wherein the high resistance portion is a void.

12. The coil component according to claim 2, wherein an average particle diameter of the plurality of soft magnetic metal particles is 0.5 μm or more and 50 μm or less.

13. The coil component according to claim 1, wherein the first surface and the second surface are parallel to each other.

14. The coil component according to claim 1, wherein the first electrode portion includes a surface that connects the first surface and the second surface and entirely overlaps the first surface when viewed from the direction orthogonal to the first surface.
